(19) United States
(12) Patent Application Publication
(10) Pub. No.: US 2022/0356816 A1
(43) Pub. Date: Nov. 10, 2022

(54) DEPOLLUTED TURBOMACHINE TEST BENCH

(71) Applicant: SAFRAN AERO BOOSTERS, Herstal (BE)

(72) Inventors: Anthony Denis Serge Weber, Herstal (BE); Maxime Eric Suzanne Albert Mathay, Herstal (BE)

(73) Assignee: SAFRAN AERO BOOSTERS, Herstal (BE)

(21) Appl. No.: 17/619,777

(22) PCT Filed: Jul. 15, 2020
(86) PCT No.: PCT/EP2020/069999

§ 371 Date: Dec. 16, 2021

(30) Foreign Application Priority Data
Jul. 16, 2019 (BE) BE2019/5459

(51) Int. Cl. F01D 25/28; F01N 3/021; G01M 15/14

(52) U.S. Cl. CPC F01D 25/285; F01N 3/021; G01M 15/14; F05D 2220/32; F05D 2260/12

(57) ABSTRACT

A depolluted test bench (I) for a turbomachine includes a channeled air duct with an air inlet and an air outlet to allow a flow of air between the air inlet and the air outlet. The channeled air duct includes a test chamber) for testing a turbomachine, the test chamber being located between the air inlet and the air outlet. A depolluting system is positioned in the air duct to depollute an air flow generated at least in part by a test of said turbomachine in the test bench. Control means control the depolluting system to allow the depolluting system to be switched on or off when a test of the turbomachine is started or stopped.

### TECHNICAL FIELD

The invention relates to a depolluting system for a turbomachine test bench.

### PRIOR ART

Test benches are used to test turbomachines. During the test phases, the fine particles and/or pollutants emitted are only very slightly dispersed in the atmosphere due to the static operation of the turbomachines tested under these conditions. The fine particles and/or pollutants emitted during these tests can therefore generate air contamination in the vicinity of the test benches.

To remedy the problem of local air pollution in general, it is known to set up air depolluting systems in certain confined areas. WO 2018/122276 A1 describes, for example, an air depolluting system in a road tunnel.

The prior art also proposes air depollution towers positioned at intersections or in parks.

However, the known depolluting systems are not satisfactory to remedy the emission of fine particles and/or pollutants from a turbomachine test bench.

### SUMMARY OF THE INVENTION

According to a first aspect, one of the aims of the present invention is to propose a turbomachine test bench allowing a significant depollution of the air flow mixed during a test. Another object of the present invention is to propose a solution for depolluting the air flow mixed by existing turbomachine test benches.

To this end, the inventors propose a depolluted test bench for a turbomachine comprising:
a channeled air duct comprising an air inlet and an air outlet to allow an air flow to circulate between said air inlet and outlet, said channeled air duct comprising a test chamber for a test of a turbomachine, said test chamber being located between said air inlet and said air outlet;
a depolluting system positioned in said air duct to depollute an air flow generated at least partially by a test of said turbomachine in the test bench;
means for controlling the depolluting system to enable the depolluting system to be switched on or off when a test of the turbomachine is started or stopped.

An advantage of the invention is that it can be implemented from an existing turbomachine test bench without degrading the performance of the bench and without disrupting the turbomachine testing.

The invention consists in introducing an air depolluting system so as not to generate high pressure drops in the test bench air flow and without creating aerodynamic turbulence in the channeled air duct. The invention also allows a good efficiency of the air depolluting system thanks to the passage through it of a large air flow corresponding to all (or almost all) of the air flow generated by the turbomachine under test.

The test bench of the invention allows significant depollution of fine particles and greenhouse gases in the air flow being mixed. The depolluting system is, for example, a mechanical effect filter, an ionising filter, or an activated carbon filter.

The depolluting system is positioned in the air duct to collect particles and pollutants present in the air drawn in and channeled into the air duct.

Preferably, the pressure drop caused by the depolluting system is less than 1500 Pa, preferably less than 1000 Pa. Such a pressure drop is detected by means of sensors positioned upstream and downstream of the depolluting system. Upstream and downstream are defined here as relating to the air flow generated by the turbomachine. Thus the air inlet is upstream of the turbomachine and the air outlet is downstream.

The depolluting system enables to collect the fine particles and/or pollutants so that they can be concentrated. Once concentrated, these fine particles and/or pollutants are conditioned for recovery, recycling or neutralisation.

Preferably, the depolluting system is positioned at said air inlet. At said air inlet means that the depolluting system is positioned at a distance from the air inlet of less than 2 m, preferably less than 1 m, even more preferably at an inlet end of the channeled air duct. Preferably, the depolluting system is fluidly connected to the duct so that the entire air flow through the duct passes through the depolluting system.

An advantage of positioning the depolluting system at the air inlet is to allow capture of particles and/or airborne pollutants. Another advantage is to allow smoothing of the air flow profile in the test chamber, upstream of the turbomachine under test. A further advantage is to allow desensitisation of the test bench to crosswind.

Preferably, the air duct comprises an inlet portion positioned between the air inlet and the test chamber, the inlet portion comprising smoothing means for obtaining a laminar air flow towards said test chamber, and the depolluting system is positioned between the smoothing means and the test chamber.

Preferably, the smoothing means comprises a plurality of vanes positioned parallel to each other so as to guide an air flow according to the orientation thereof. Preferably, the vanes are guide vanes. Preferably, the smoothing means further allow the main propagation direction of the air flow to be rotated by 90°. For example, the smoothing means comprise a plurality of tubes arranged parallel to each other.

The advantage of having smoothing means in addition to the depolluting system at the inlet allows a smoothing of the air flow profile in the test chamber that is superior to the smoothing obtained with the depolluting system or the smoothing means alone. The smoothing of the air profile provides a laminar air flow towards the test chamber. Furthermore, the advantage of placing the depolluting system between the smoothing means and the turbomachine under test allows a smoothing of the air flow in a straight section of the channeled air duct, resulting in a more qualitative smoothing so as to have a well laminar air flow.

Preferably, the depolluting system is positioned at said air outlet. At said air outlet means that the depolluting system is positioned at a distance from the air outlet of less than 2 m, preferably less than 1 m, even more preferably at an outlet end of the channeled air duct. Preferably, the depolluting system is fluidly connected to the duct so that the entire air flow through the duct passes through the depolluting system.

An advantage of positioning the depolluting system at said air outlet is to allow capture of particles and/or pollutants from combustion in the turbomachine and particles and/or pollutants from the atmosphere. A further advantage is that such positioning at the outlet does not generate the air flow disturbances at the inlet of the test bench.

Preferably, the air duct further comprises acoustic reduction means at said air outlet, said depolluting system being positioned at said acoustic reduction means. At said air outlet means that the acoustic reduction means are positioned at a distance from the air outlet of less than 2 m, preferably less than 1 m, even more preferably at an outlet end of the channeled air duct. Preferably, the acoustic reduction means are fluidly connected to the duct so that the entire air flow through the duct passes through the acoustic reduction means. The depolluting system is positioned at the acoustic reduction means that they are positioned at a distance of less than 2 m, preferably less than 1 m from each other, and even more preferably adjacent.

The advantage of positioning the depolluting system at the level of the noise reduction means allows, either in isolation or in combination:
to simplify the acoustic reduction means;
to improve the acoustic reduction when used in combination with the acoustic reduction means known in the prior art;
to use part of the pressure drop normally required for acoustic reduction as a pressure drop used for depollution.

Preferably, the air duct comprises an outlet portion positioned between said test chamber and said air outlet.

The outlet portion is a blast basket. The pressure drops that occur in the outlet portion are dominant and govern the flow rate of the test bench. The outlet section collects the air flow generated by the turbomachine. The air outlet of the test bench allows the collected air flow to be discharged to the outside of the test bench.

Preferably, said air duct further comprises an air flow pipe portion with a substantially circular cross-section positioned between said test chamber and said outlet portion.

The air flow pipe portion is positioned between the test chamber and the outlet portion so as to channel the air flow generated by the turbomachine. The pipe portion is a duct, preferably of circular cross-section. The pipe portion is an augmenting duct, i.e., preferably having a larger cross-section than the outlet cross-section of the turbomachine. Thus, the pipe portion allows the entire air flow generated by the turbomachine to be collected.

The essentially circular cross-section of the air flow pipe portion enables to avoid generating turbulence directly at the turbomachine outlet. The air flow pipe portion enables to direct the air flow generated by the turbomachine towards the air outlet portion while limiting the generation of a turbulent air flow directly at the turbomachine outlet.

Preferably, the outlet portion comprises a blast basket. For example, the blast basket has a substantially circular cross-section. For example, it is positioned in the outlet portion so that it is in line with the air flow pipe portion.

Preferably, the turbomachine is an aircraft turbomachine.

The advantage of testing an aircraft turbomachine is that the turbomachine generates a very large air flow, allowing the clearance of an air flow equivalent to the generated air flow.

Preferably, the aircraft turbomachine is dual-flow.

The advantage of using a dual-flow turbomachine is that it enables to generate an even greater air flow than a single-flow turbomachine, with lower fuel consumption, and therefore lower emissions of fine particles and/or pollutants. This results in a better depollution efficiency.

The means for controlling the depolluting system enables to synchronise the start-up of the test and, if necessary, the start-up of the depolluting system. Preferably, the control means are included in the control means allowing to implement the turbomachine test. Preferably, starting or stopping the turbomachine under test automatically causes the filtration to be started or stopped.

Preferably, the depolluting system is adapted not to induce any pressure drop to an air flow flowing through the test bench.

By means of deactivating the depolluting system, it is possible to continue an engine test even when the depolluting means would be rendered non-operational.

Preferably, the control means are adapted to deactivate said depolluting system.

The control means are capable of activating and deactivating the depolluting system.

Preferably, the test bench further comprises a bypass fluidly connected to the air duct to allow an air flow to bypass the depolluting system.

Preferably, the test bench comprises sensors connected to the monitoring means. The control means, on the basis of the data sent by the sensors, are provided to control the efficiency and the correct operation of the depolluting system. The sensors that are connected to the control means allow to detect a malfunction of the depolluting system, so as to deactivate it or to make the bypass operational. A malfunction of the depolluting system is, for example, a pressure drop that is too great and that would hinder the proper conduct of the turbomachine test. For example, the sensors are static pressure sensors positioned on either side of the depolluting system.

Preferably, the depolluting system comprises at least one of the following depolluting means:
fine particle sensor,
fine particle filter, by ionisation or mechanical
an air washing unit with a water flow,
filter for capturing greenhouse gases.

Possible variants of the turbomachine test bench of the invention include one, two, or three depolluting systems. For example, in the case of two or three depolluting systems, these allow the collection of fine particles and/or pollutants of different size and/or nature. It is thus particularly advantageous to have several locations in the test bench for the installation of at least one depolluting system.

According to a second aspect, the invention relates to an air depollution method for a test bench of a turbomachine and comprising the following steps:
a. providing a test bench according to the first aspect, said test bench (1) further comprising sensors (12) connected to a control unit (11);
b. providing and placing a turbomachine in the test chamber;
c. starting said turbomachine so as to generate said air flow in said channeled air duct;
d. activating said depolluting system to collect fine particles and/or pollutants to depollute at least partially an air flow generated at least partially by the turbomachine in operation;
e. monitoring said turbomachine in operation and the depollution of the air flow of the previous step, and, setting up a monitoring on the basis of signals transmitted from said sensors (12) to said control unit (11), said monitoring allowing to pass to step f. according to the signals transmitted by said sensors (12);
f. shutting down the turbomachine;
g. deactivating said depolluting system;
h. discharging said collected pollutants.

The various embodiments and associated advantages of the test bench according to the first embodiment apply to the process according to the second embodiment mutatis mutandis.

### BRIEF DESCRIPTION OF THE FIGURES

These and other aspects of the invention will be clarified in the detailed description of particular embodiments of the invention, reference being made to the drawings of the figures, in which:

FIGS. 1, 2, 3, and 4 show embodiments of the invention.

The drawings of the figures are not to scale. Generally, similar elements are denoted by similar references in the figures. The presence of reference numbers in the drawings cannot be regarded as limiting, even when such numbers are indicated in the claims.

### DETAILED DESCRIPTION OF SOME EMBODIMENTS OF THE INVENTION

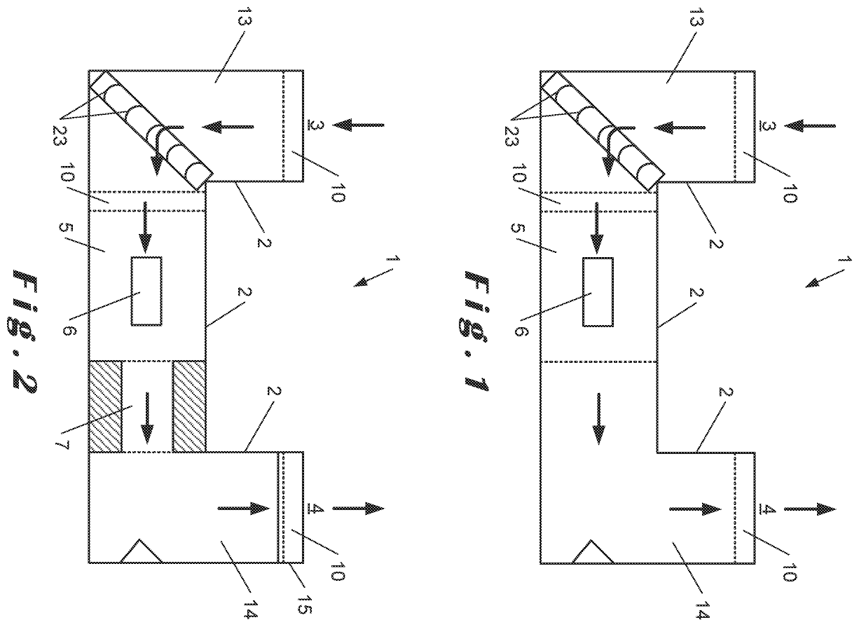

FIG. 1 shows an example of an embodiment of the invention. The test bench 1 comprises a channeled air duct 2. The channeled air duct 2 is, for example, a duct of rectangular cross-section. The channeled air duct 2 allows the circulation of an air flow between an air inlet 3 and an air outlet 4. The air flow between the air inlet 3 and the air outlet 4 is generated by the operation of the turbomachine 6 under test. The turbomachine 6 is positioned so that in operation it creates a negative pressure at the air inlet 3 and a positive pressure at the air outlet 4. The turbomachine 6 is positioned in a test chamber 5 of the channeled air duct 2. The test chamber 5 is positioned between an air inlet portion 13 and an air outlet portion 14. The air inlet portion 13 preferably comprises air flow smoothing means 23 so that the testing of the turbomachine 6 is carried out under optimum laminar air flow conditions.

FIG. 1 shows three possible locations of the depolluting system 10 in the channeled air duct 2 of the engine test bench 1. According to a first embodiment, the depolluting system 10 is positioned at the air inlet 3, i.e. at an inlet opening of the air inlet portion 13. According to a second embodiment, the depolluting system 10 is positioned between the smoothing means 23 and the turbomachine 6. According to a third embodiment, the depolluting system 10 is positioned at the air outlet 4, i.e. at an outlet opening of the air outlet portion 14.

FIG. 2 repeats the elements of the test bench 1 described for FIG. 1. In addition, FIG. 2 shows an embodiment of the invention in which an air flow pipe portion 7 is positioned between the test chamber 5 and the outlet portion 14. This air flow pipe portion 7 allows for better management of the air flow at the outlet so that the air flow exiting the turbomachine 6 does not disturb the air flow entering the turbomachine 6. In the embodiment shown in FIG. 2, acoustic reduction means 15 are positioned at the air outlet 4. According to the third embodiment described in FIG. 1, the depolluting means 10 are included in the acoustic reduction means 15. For example, the depolluting means 10 replaces the acoustic reduction means 15 because the depolluting means 10 allows a similar acoustic reduction as the acoustic reduction means 15.

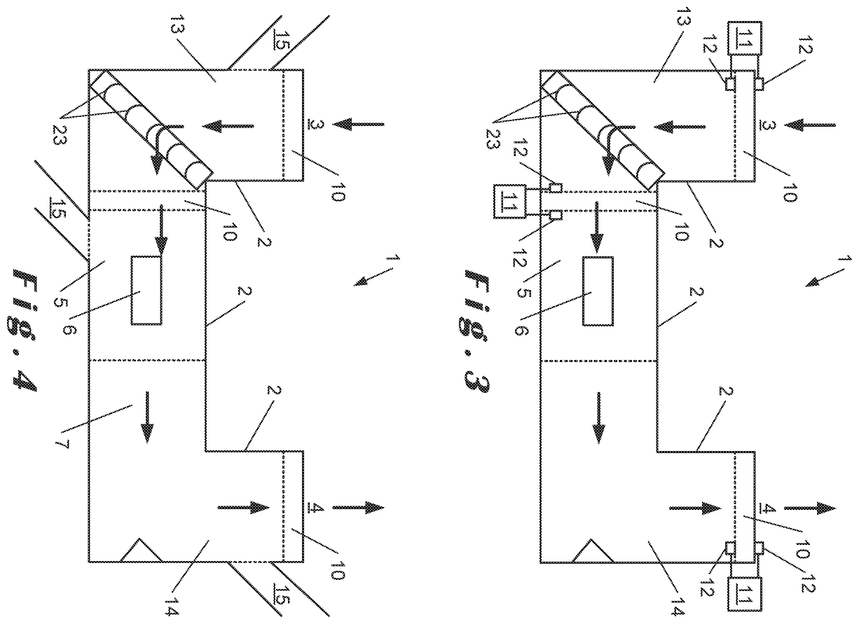

FIG. 3 shows the elements of the test bench 1 described in FIG. 1. In addition, the elements described in FIG. 2 can be combined with the elements described in FIG. 3. FIG. 3 shows an embodiment of the invention in which the test bench 1 comprises sensors 12 connected to a control means 11. The sensors 12 are positioned on either side of the depolluting system 10 regardless of the depolluting system embodiment described in FIG. 1. Preferably, the sensors 12 comprise at least one sensor upstream and one sensor downstream of the turbomachine 6. Thanks to the sensors 12 connected to the control means 11, it is possible to detect the presence of an air flow passing through the depolluting system 10. This is of interest in order to be able to control the correct operation of the depolluting system 10 in order to be able to prevent a clogging of the depolluting system 10. This control system (control means 11 and sensors 12) also enables to evaluate the level of depollution of the air flow in order to adjust, for example, the level of activation of the depolluting system 10.

FIG. 4 shows the elements of the test bench 1 described in FIG. 1. Furthermore, the elements described in FIGS. 2 and 3 can be combined together or independently with the elements described in FIG. 4. FIG. 4 shows an embodiment of the invention in which the test bench 1 comprises a bypass 15 so as to allow an air flow with acceptable pressure drops to be maintained at the inlet of the turbomachine 6 when a malfunction of the depolluting system 10 occurs. A malfunction is, for example, a partial or total clogging of the depolluting system 10. Thus, in the case of the first and second described positions of the depolluting system, the bypass 15 ensures that there is no pressure drop upstream of the turbomachine 6 that causes a pressure difference of less than 15 mbar between the upstream test chamber and the air inlet 3 of the channeled duct 2. In the case of the third embodiment, when the depolluting system 10 is positioned at the air outlet 4, the bypass 15 enables to guarantee the correct evacuation of the air flow in the event of a malfunction of the depolluting system 10. Indeed, in the event of a clogging during the test of the turbomachine 6, an overpressure in the outlet portion 14 could hinder the correct conduct of the test and present risks of damage to the test bench 1.

The present invention has been described in relation to specific embodiments, which are purely illustrative and should not be considered limiting. In general, the present invention is not limited to the examples illustrated and/or described above. The use of the verbs “comprise”, “include”, “contain”, or any other variant, as well as their conjugations, can in no way exclude the presence of elements other than those mentioned. The use of the indefinite article “a”, “an”, or the definite article “the” to introduce an element does not exclude the presence of a plurality of such elements. The reference numbers in the claims do not limit their scope.

In summary, the invention may also be described as follows. A depolluted test bench 1 for a turbomachine 6 comprising:
a channeled air duct 2 comprising an air inlet 3 and an air outlet 4 to allow an air flow to circulate between said air inlet 3 and outlet 4, said channeled air duct 2 comprising a test chamber 5 for a test of a turbomachine 6, said test chamber 5 being located between said air inlet 3 and said air outlet 4;
a depolluting system 10 positioned in said air duct 2 to depollute an air flow generated at least partially by a test of said turbomachine in the test bench;
means (11) for controlling said depolluting system (10) to enable the depolluting system (10) to be switched on or off when a test of said turbomachine (6) is started or stopped.

1. A depolluted test bench for a turbomachine comprising:
a channeled air duct comprising an air inlet and an air outlet to allow an air flow to circulate between said air inlet and outlet, said channeled air duct further comprising a test chamber configured for a test of a turbomachine, said test chamber being located between said air inlet and said air outlet;
a depolluting system positioned in said air duct and configured to depollute an air flow generated at least partially by a test of said turbomachine in the test bench; and
means for controlling said depolluting system to enable to switch on or switch off the depolluting system when a test of said turbomachine is started or stopped.

2. The test bench according to claim 1, wherein said depolluting system is positioned at said air inlet.

3. The test bench according to claim 1, wherein said air duct further comprises an inlet portion positioned between said air inlet) and said test chamber, said inlet portion comprising smoothing means that obtains a laminar air flow towards said test chamber, and
wherein said depolluting system is positioned between said smoothing means and said test chamber.

4. The test bench according to claim 1, wherein said depolluting system is positioned at said air outlet.

5. The test bench according to claim 1, wherein said air duct further comprises acoustic reduction means at said air outlet, said depolluting system being positioned at said acoustic reduction means.

6. The test bench according to claim 1, wherein said air duct further comprises an outlet portion positioned between said test chamber and said air outlet.

7. The test bench according to claim 6, wherein said air duct further comprises an air flow pipe portion with a substantially circular cross-section positioned between said test chamber and said outlet portion.

8. The test bench according to claim 1, wherein said turbomachine is an aircraft turbomachine.

9. The test bench according to claim 1, wherein said depolluting system is configured not to induce any pressure drop to an air flow flowing through said test bench.

10. The test bench according to claim 9, wherein said control means are adapted to deactivate said depolluting system.

11. The test bench according to claim 1, further comprising a bypass fluidly connected to said air duct to allow an air flow to bypass said depolluting system.

12. The test bench according to claim 1, wherein said depolluting system comprises at least one of the following depolluting means:
fine particle sensor,
fine particle filter, by ionisation or mechanical,
an air washing unit with a water flow, and
filter for capturing greenhouse gases.

13. An air depollution method for a test bench of a turbomachine and comprising the following steps:
a. providing a test bench according to claim 1, said test bench further comprising sensors connected to a control unit;
b. providing and placing a turbomachine in the test chamber;
c. starting said turbomachine to generate said air flow in said channeled air duct;
d. activating said depolluting system to collect fine particles and/or pollutants to depollute at least partially an air flow generated at least partially by the turbomachine in operation;
e. monitoring said turbomachine in operation and the depollution of the air flow of the previous step, and setting up a monitoring on the basis of signals transmitted from said sensors to said control unit, said monitoring allowing to pass to step f. according to the signals transmitted by said sensors;
f. shutting down the turbomachine;
g. deactivating said depolluting system; and
h. discharging said collected pollutants.
